(19) United States
(12) Patent Application Publication
(10) Pub. No.: US 2018/0269635 A1
(43) Pub. Date: Sep. 20, 2018

(54) ELECTRIC CONDUCTION SYSTEM AND MALE TERMINAL

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Takeo Uchino, Yokkaichi, Mie (JP); Takeshi Uraki, Yokkaichi, Mie (JP); Yasuo Oomori, Yokkaichi, Mie (JP)

(21) Appl. No.: 15/759,261

(22) PCT Filed: Sep. 7, 2016
(86) PCT No.: PCT/JP2016/076270

§ 371 Date: Mar. 12, 2018

(30) Foreign Application Priority Data
Sep. 14, 2015 (JP) 2015-181022
Nov. 4, 2015 (JP) 2015-216715

(51) Int. Cl. H01R 13/707; H01R 13/03; H01R 13/66; H02H 3/08

(52) U.S. Cl. CPC H01R 13/707; H02H 3/08; H01R 13/6683; H01R 13/03

(57) ABSTRACT

Provided is an electric conduction system and a male terminal that prevent arc discharge by cutting off power supply prior to the occurrence of arc discharge. The male terminal is connected to the female terminal of the electric conduction apparatus, and power is supplied from the electric conduction apparatus. The male terminal includes a first resistance portion having a resistance value R1 on its rear-end side and a second resistance portion having a resistance value R2 on its front-end side. Accordingly, the resistance value of the power supply path varies depending on the amount the male terminal is inserted into the female terminal. By determining whether the electric current amount varies in accordance with a change in the resistance value of the power supply path, the electric conduction apparatus can cut off power supply prior to the male terminal coming off the female terminal, thus preventing an arc discharge.

### CROSS-REFERENCE TO RELATED APPLICATIONS

This application is the U.S. national stage of PCT/JP2016/076270 filed Sep. 7, 2016 which claims priority of Japanese Application Nos. JP 2015-181022 filed Sep. 14, 2015 and JP 2015-216715 filed Nov. 4, 2015.

### TECHNICAL FIELD

The present invention relates to an electric conduction system and a male terminal that prevent arc discharge.

### BACKGROUND

It is known that when a connection between contact points is opened or closed, a potential difference between the contact points is greater than the so-called minimum arc voltage and the electric current at the contact point is greater than the minimum arc electric current, then an arc discharge occurs. In particular, if a connection between contact points through which a direct electric current flows is opened or closed, then the discharge lasts for a longer period of time compared to the case where an alternating electric current flows through the contact points. If an arc discharge occurs between the contact points, then there is a concern that the contact points will be oxidized or blackened, or defects such as seizures will occur due to the high temperature accompanying an arc discharge. Also, there is a concern that the surrounding electronic circuitry will be adversely influenced by electromagnetic wave noise caused by arc discharge.

In JP 2010-199521A, an LED lighting apparatus is proposed which samples an electric amount corresponding to a lit LED and compares the sampled data with reference data, and if there is a difference between the data of the electric amounts that corresponds to a predetermined voltage that is lower than 13V, which is the minimum voltage of arc discharge, then the LED lighting apparatus determines that arc discharge has occurred, and when it determines that arc discharge occurs, it stops or reduces the output from the DC power source.

The LED lighting apparatus disclosed in JP 2010-199521A is configured to stop or reduce the output from the DC power source if it is determined that arc discharge has occurred, and is configured to take measures against arc discharge after the occurrence of arc discharge. However, once an arc discharge occurs, no matter how fast the power supply is cut off, there is a possibility that the contact points will be impaired.

The present invention has been achieved in light of the above-described issues, and provides an electric conduction system and a male terminal that prevent arc discharge by cutting off power supply in a stage prior to the occurrence of arc discharge.

### SUMMARY

An electric conduction system according to the present invention includes a harness having a first terminal having a male terminal structure or a female terminal structure, and an electric conduction apparatus having a second terminal that fits to the first terminal and has a female terminal structure or a male terminal structure. In the electric conduction system in which the electric conduction apparatus supplies power to the harness in a state in which the first terminal and the second terminal are fitted to each other, the first terminal and the second terminal are configured such that a resistance value of a power supply path through which the electric conduction apparatus supplies power to the harness varies depending on a position up to which a male terminal is inserted into a female terminal, and the electric conduction apparatus includes a detection unit configured to detect an amount of an electric current flowing to the harness through power supply, and an electric conduction stopping unit configured to stop power supply if the amount of the electric current detected by the detection unit varies by a predetermined amount.

Also, in the electric conduction system according to the present invention, the male terminal has a first portion that has a first resistance value and is provided on its rear-end side and a second portion that has a second resistance value and is provided on its front-end side, with respect to a direction in which the male terminal is inserted into the female terminal.

Also, in the electric conduction system according to the present invention, the second resistance value is greater than the first resistance value.

Also, in the electric conduction system according to the present invention, the electric conduction stopping unit stops power supply if the amount of the electric current detected by the detection unit decreases.

Also, with a male terminal according to the present invention, the male terminal to be fitted to a female terminal includes a first portion that has a first resistance value and is provided on its rear-end side and a second portion that has a second resistance value and is provided on its front-end side, with respect to a direction in which the male terminal is inserted into the female terminal.

In the electric conduction system according to the present invention, a harness having a first terminal is connected to a second terminal of the electric conduction apparatus, and power is supplied from the electric conduction apparatus to the harness in a state in which the first terminal and the second terminal are fitted to each other. Either the first terminal or the second terminal is a male terminal and the other is a female terminal. In such a system, when the harness comes off from the electric conduction apparatus, that is, when the first terminal comes off from the second terminal, there is a possibility that arc discharge will occur.

In view of this, in the present invention, the terminals are configured such that the resistance value of the power supply path through which the electric conduction apparatus supplies power to the harness varies depending on the position up to which the male terminal is inserted into the female terminal. The electric conduction apparatus detects the amount of electric current flowing to the harness through power supply and stops the power supply if this electric current amount varies by a predetermined amount.

The electric conduction apparatus is configured such that when the male terminal comes off from the female terminal, the resistance value varies depending on the position up to which the male terminal is inserted into the female terminal, and thus the resistance value varies in a stage prior to the male terminal completely coming off, and the amount of electric current flowing from the electric conduction apparatus to the harness varies. Thus, the electric conduction apparatus can detect the state in which the terminal is about to come off by determining whether or not the electric current amount varies in accordance with a change in the resistance value of the power supply path. By cutting off power supply in accordance with a change in the electric current amount, the electric conduction apparatus can cut off power supply in a stage prior to the terminal coming off, and cut off power supply before there is an arc discharge.

Also, in the present invention, the male terminal is provided with the first portion having the first resistance value on its rear-end side and is provided with the second portion having the second resistance value on its front-end side, with respect to the direction in which the male terminal is inserted into the female terminal. Accordingly, in a state in which the male terminal is tightly fitted to the female terminal, power is supplied between the electric conduction apparatus and the harness via the first portion of the male terminal. In contrast, power is supplied via only the second portion of the male terminal immediately before the male terminal comes off from the female terminal. Because the first portion and the second portion have different resistance values, it is possible to change the resistance value of the power supply path between the electric conduction apparatus and the harness depending on the position up to which the male terminal is inserted into the female terminal.

Also, in the present invention, the second resistance value of the second portion provided on the front-end side of the male terminal is larger than the first resistance value of the first portion provided on its rear-end side. Accordingly, the resistance value of the power supply path can be varied to a higher value immediately before the male terminal comes off from the female terminal.

Also, with this configuration, by changing the resistance value of the power supply path to a higher value, the amount of electric current flowing through the power supply path decreases. In view of this, the electric conduction apparatus is capable of determining that there is a possibility that arc discharge will occur when the amount of detected electric current decreases, and stopping power supply.

According to the present invention, terminals are configured such that a resistance value of a power supply path through which an electric conduction apparatus supplies power to a harness varies depending on a position up to which a male terminal is inserted into a female terminal, and the electric conduction apparatus stops power supply when an amount of electric current in the power supply path varies by a predetermined amount, can cut off the power supply in a stage prior to the occurrence of arc discharge, and prevent the occurrence of arc discharge.

### BRIEF DESCRIPTION OF DRAWINGS

FIG. 1 is a block diagram showing the configuration of an electric conduction system according to this embodiment.

FIG. 2 is a schematic diagram showing the configuration of a male terminal and a female terminal according to this embodiment.

FIG. 3 is a table showing examples of materials of a first resistance portion and a second resistance portion.

FIG. 4 is a graph illustrating a change in the amount of electric current flowing from an electric conduction apparatus to a harness.

FIG. 5 is a flowchart showing a procedure of power supply control performed by the electric conduction apparatus.

FIG. 6 is a schematic diagram showing the configuration of a male terminal and a female terminal according to a modification.

### DETAILED DESCRIPTION OF PREFERRED EMBODIMENTS

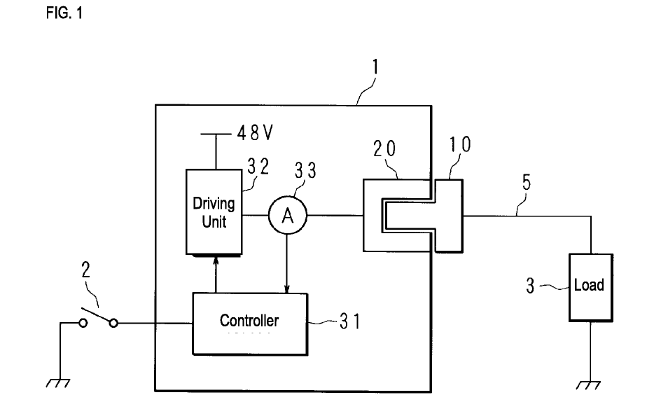

Hereinafter, the present invention will be specifically described with reference to the drawings showing embodiments. FIG. 1 is a block diagram showing the configuration of an electric conduction system according to the present embodiment. In the electric conduction system according to the present embodiment, for example, a load 3 such as a heater or a lamp is installed in a vehicle, a switch 2 that can be operated to switch on/off this load 3 is provided in the vicinity of a driver seat of the vehicle, and an electric conduction apparatus 1 supplies power to the load 3 depending on the state of the switch 2. The electric conduction apparatus 1 and the load 3 are connected to each other via a harness 5 arranged in the vehicle. Also, the electric conduction apparatus 1 and the harness 5 are connected to each other by fitting the male terminal 10 provided at one end of the harness 5 to a female terminal 20 provided in a casing or the like of the electric conduction apparatus 1 as appropriate.

The electric conduction apparatus 1 according to the present embodiment includes a controller 31, a driving unit 32, an electric current detection unit 33, for example. The controller 31 is constituted by an arithmetic processing apparatus such as a CPU (central processing unit) and a storage apparatus such as a ROM (read only memory) or a RAM (random access memory), and is configured to detect the on/off state of the switch 2 and performs processing for controlling supply of power to the load 3 by giving a driving command to the driving unit 32 in accordance with the detection results.

Power with a voltage of 48 V is supplied to the driving unit 32 from a power source such as a battery of the vehicle. The driving unit 32 outputs power having a voltage value of 48 V in response to a command given by the controller 31. The power output from the driving unit 32 is supplied to the load 3 via internal wires of the electric conduction apparatus 1, the female terminal 20, the male terminal 10, and the harness 5. That is, power is supplied to the load 3 from the electric conduction apparatus 1.

The electric current detection unit 33 is disposed in a power supply path extending from the driving unit 32 to the female terminal 20, detects the amount of electric current flowing through this power supply path, and communicates this to the controller 31. The controller 31 determines whether or not there is an abnormality, based on the amount of the electric current detected by the electric current detection unit 33, and if it is determined that there is an abnormality, the controller 31 stops the supply of power to the load 3 by stopping the operation of the driving unit 32.

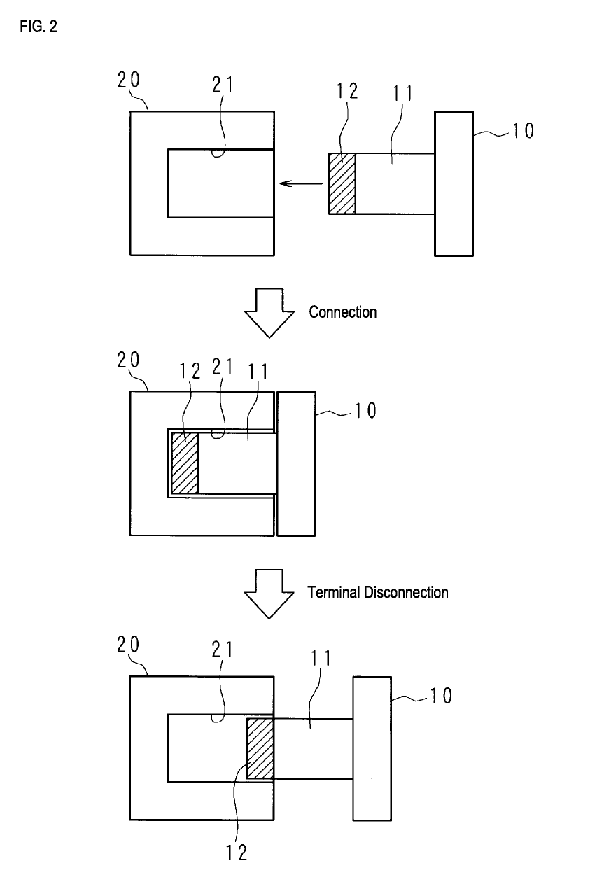

FIG. 2 is a schematic diagram showing the configuration of the male terminal 10 and the female terminal 20 according to the present embodiment. Note that in FIG. 2, the drawing at the top shows a state prior to connection between the male terminal 10 and the female terminal 20, the drawing in the middle shows a state in which the male terminal 10 and the female terminal 20 are connected to each other, and the drawing at the bottom shows a state immediately before the male terminal 10 comes off from the female terminal 20.

The male terminal 10 has a conductive rod-shaped portion, and this rod-shaped portion is electrically connected to an electric wire of the harness 5. The female terminal 20 is provided with a hole 21 into which the rod-shaped portion of the male terminal 10 is inserted. At least an inner surface of the hole 21 of the female terminal 20 is made of a conductive material, and the inner surface of the hole 21 is electrically connected to the internal wire of the electric conduction apparatus 1. By inserting the rod-shaped member of the male terminal 10 into the hole 21 of the female connector 20, the male terminal 10 and the female terminal 20 are fitted to each other, the male terminal 10 and the female terminal 20 are electrically connected to each other, and the electric conduction apparatus 1 and the harness 5 are electrically connected to each other.

The rod-shaped portion of the male terminal 10 according to the present embodiment has a first resistance portion 11 provided on its rear-end side and a second resistance portion 12 provided on its front-end side. The first resistance portion 11 and the second resistance portion 12 are provided with different resistance values by plating a metal rod-shaped member, which serves as the base, with different types of metal, for example. When the resistance value of the first resistance portion 11 is R1 and the resistance value of the second resistance portion 12 is R2, metal for plating is selected such that R1 is less than R2 (R1<R2) in the present embodiment. For example, it is conceivable that the first resistance portion 11 is plated with platinum, and the second resistance portion 12 is plated with palladium, nickel, or the like.

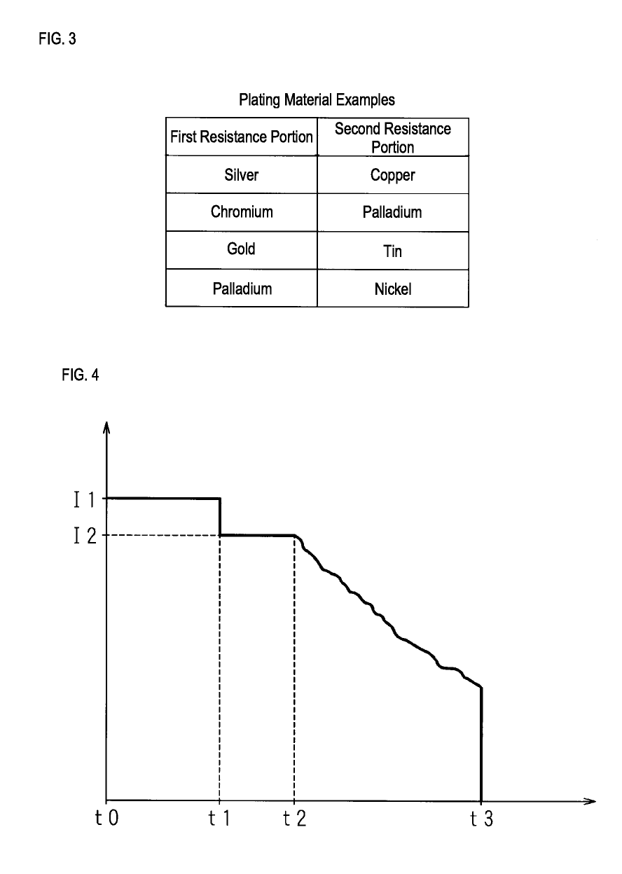

FIG. 3 is a table showing examples of materials of the first resistance portion 11 and the second resistance portion 12. Examples of the metal that can be adopted as plating for the first resistance portion 11 and the second resistance portion 12 include silver (1.62), copper (1.69), gold (2.4), chromium (7.1), platinum (8.8), palladium (10.08), tin (11.5), and nickel (11.8). Note that the numerical values in brackets written after the name of each metal are the electric resistivity of the metals in μΩ·cm.

For example, the first resistance portion 11 can be plated with silver, and the second resistance portion 12 can be plated with copper. Or, the first resistance portion 11 can be plated with chromium, and the second resistance portion 12 can be plated with palladium. Or, the first resistance portion 11 can be plated with gold, and the second resistance portion 12 can be plated with tin. Or, the first resistance portion 11 can be plated with palladium, and the second resistance portion 12 can be plated with nickel.

Note that the metals that are adopted as plating for the first resistance portion 11 and the second resistance portion 12 are not limited to the above, and metals other than the above may also be adopted. Metal alloys of a plurality of metals may also be used. Also, the combinations of metals shown in FIG. 3 are merely examples, and are not limited to these. Furthermore, the materials of the first resistance portion 11 and the second resistance portion 12 may be the same metal, and a difference in the resistance value may also be provided by providing a difference to their shape.

In a state in which the male terminal 10 and the female terminal 20 are normally connected to each other, that is, in a state in which the rod-shaped portion of the male terminal 10 is inserted into the hole 21 of the female terminal 20 all the way to its rear end (see the middle in FIG. 2), the first resistance portion 11 and the second resistance portion 12 of the male terminal 10 and the inner surface of the hole 21 of the female terminal 20 are in contact with each other and electrically connected to each other. In this state, an electric current flows mainly between the first resistance portion 11 having a low resistance value and the inner surface of the female terminal 20. The amount of the electric current flowing at this time depends on the resistance value R1 of the first resistance portion 11 (or a resistance obtained by combining the resistance value R1 of the first resistance portion 11 and the resistance value R2 of the second resistance portion 12).

Here, let us consider a terminal disconnection where the male terminal 10 comes off from the female terminal 20 for some reason. At this time, in a stage prior to the male terminal 10 completely coming off from the female terminal 20, as shown in the bottom in FIG. 2, the first resistance portion 11 of the male terminal 10 protrudes from the hole 21 of the female terminal 20 but the second resistance portion 12 is still accommodated in the hole 21. In this state, only the second resistance portion 12 of the male terminal 10 is in contact with the inner surface of the hole 21 of the female terminal 20, and thus electric current flows between the second resistance portion 12 and the inner surface of the female terminal 20. The electric current flowing at this time depends on the resistance value R2 of the second resistance portion 12.

That is, the male terminal 10 and the female terminal 20 according to the present embodiment are configured such that the resistance value of the power supply path through which the electric conduction apparatus 1 supplies power to the harness 5 varies depending on the position up to which the male terminal 10 is inserted into the female terminal 20. Because the amount of the electric current flowing from the electric conduction apparatus 1 to the harness 5 varies due to this change in the resistance value, the electric conduction apparatus 1 can detect that the male terminal 10 is about to come off from the female terminal 20 based on the electric current detected by the electric current detection unit 33.

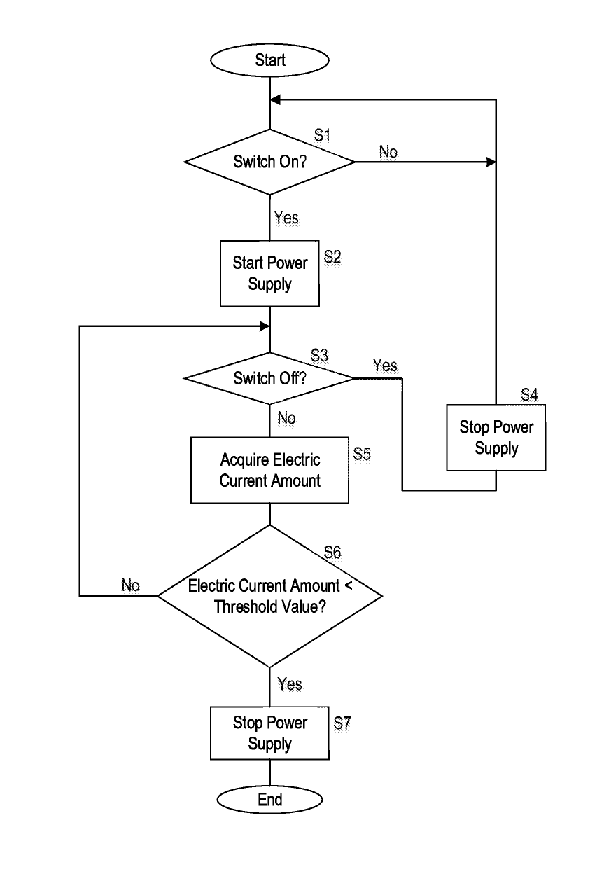

FIG. 4 shows a graph illustrating a change in the amount of the electric current flowing from the electric conduction apparatus 1 to the harness 5. The graph shown in FIG. 4 shows a change in the electric current amount where the horizontal axis represents the time and the vertical axis represents the amount of electric current detected by the electric current detection unit 33, if the male terminal 10 is gradually moved at a constant speed, in a direction in which the male terminal 10 is removed from the female terminal 20, from a state in which the male terminal 10 and the female terminal 20 are completely connected to each other. In an interval from time t0 to time t1, the first resistance portion 11 of the male terminal 10 is accommodated in the hole 21 of the female terminal 20, and an electric current I1 depending on the resistance value R1 of the first resistance portion 11 flows.

At the time t1, the first resistance portion 11 of the male terminal 10 protrudes from the hole 21 of the female terminal 20, and only the second resistance portion 12 is accommodated in the hole 21 (the state in the bottom in FIG. 2). In an interval from the time t1 to time t2 during which the state in which only the second resistance portion 12 is in contact with the inner surface of the hole 21 of the female terminal 20 is maintained, an electric current 12 flows that depends on the resistance value R2 of the second resistance portion 12.

At the time t2, the second resistance portion 12 of the male terminal 10 protrudes from the hole 21 of the female terminal 20, arc discharge occurs between the male terminal 10 and the female terminal 20, and an electric current caused by this arc discharge flows between the male terminal 10 and the female terminal 20. The electric current flowing at this time decreases as the distance between the male terminal 10 and the female terminal 20 increases. At the time t3 at which the distance between the male terminal 10 and the female terminal 20 exceeds a predetermined distance, there is no arc discharge, and no electric current flows between the male terminal 10 and the female terminal 20.

The electric conduction apparatus 1 according to the present embodiment stops power supply if the amount of the electric current detected by the electric current detection unit 33 varies from I1 to 12 shown in FIG. 4. The controller 31 of the electric conduction apparatus 1 can be configured to store a threshold value Ith (where I1>Ith>I2) at this time, for example, and stop the power supply if the amount of the electric current detected by the electric current detection unit 33 is not more than Ith. The threshold value Ith can be predetermined based on the resistance value R1 of the first resistance portion 11, the resistance value R2 of the second resistance portion 12, an applied voltage value, the resistance value of the load 3, or the like.

FIG. 5 is a flowchart showing a procedure of the power supply control performed by the electric conduction apparatus 1. The controller 31 of the electric conduction apparatus 1 acquires the on/off state of the switch 2 and determines whether or not the switch 2 is in the on state (step S1). If the switch 2 is not in the on state (S1: NO), the controller 31 waits until the switch 2 is turned on. If the switch 2 is in the on state (step S1: YES), the controller 31 starts to supply power to the load 3 by giving a driving command to the driving unit 32 (step S2). Thereafter, the controller 31 determines whether or not the switch 2 is in the off state (step S3). If the switch 2 is in the off state (step S3: YES), the controller 31 stops supply of power to the load 3 (step S4) by giving a stop command to the driving unit 32, and returns the procedure to step 51.

If the switch 2 is not in the off state (step S3: NO), the controller 31 acquires the amount of the electric current detected by the electric current detection unit 33 (step S5). The controller 31 determines whether or not the acquired electric current amount is less than the predetermined threshold value Ith (step S6). If the electric current amount is not less than the threshold value Ith (step S6: NO), the controller 31 returns the procedure to step S3. If the electric current amount is less than the threshold value Ith (step S6: YES), the controller 31 stops supply of power to the load 3 by giving a stop command to the driving unit 32 (step S7), and ends the procedure.

In the electric conduction system according to the present embodiment having the above configuration, the male terminal 10 of the harness 5 is connected to the female terminal 20 of the electric conduction apparatus 1, and power is supplied to the harness 5 from the electric conduction apparatus 1 in a state in which the male terminal 10 and the female terminal 20 are fitted to each other. The male terminal 10 and the female terminal 20 are configured such that the resistance value of the power supply path through which the electric conduction apparatus 1 supplies power to the harness 5 varies depending on the position up to which the male terminal 10 is inserted into the female terminal 20. Because the resistance value varies depending on the position up to which the male terminal 10 is inserted into the female terminal 20, when the male terminal 10 comes off from the female terminal 20, the resistance value varies in a stage prior to the male terminal 10 completely coming off, and the amount of the electric current flowing to the harness 5 from the electric conduction apparatus 1 varies. The electric conduction apparatus 1 can detect a state in which the male terminal 10 is about to come off from the female terminal 20, by determining whether or not the electric current amount varies in accordance with a change in the resistance value of the power supply path. Accordingly, by cutting off power supply in accordance with a change in the amount of the electric current detected by the electric current detection unit 33, the electric conduction apparatus 1 can cut off the power supply in a stage prior to the male terminal 10 coming off from the female terminal 20, and cut off the power supply before there is an arc discharge.

Also, the male terminal 10 in the present embodiment is provided with a first resistance portion 11 having the resistance value R1 on its rear-end side and a second resistance portion 12 having the resistance value R2 on its front-end side, with respect to the direction in which the male terminal 10 is inserted into the female terminal 20. Accordingly, power is supplied from the electric conduction apparatus 1 to the harness 5 via the first resistance portion 11 of the male terminal 10 in a state in which the male terminal 10 is tightly fitted to the female terminal 20. In contrast, power is supplied via only the second resistance portion 12 of the male terminal 10 immediately before the male terminal 10 comes off from the female terminal 20. Use of the first resistance portion 11 and the second resistance portion 12 with different resistance values makes it possible to vary the resistance value of the power supply path between the electric conduction apparatus 1 and the harness 5 depending on the position up to which the male terminal 10 is inserted into the female terminal 20.

Also, in the present embodiment, the resistance value R2 of the second resistance portion 12 of the male terminal 10 is greater than the resistance value R1 of the first resistance portion 11. Accordingly, the resistance value of the power supply path can be varied to a higher value immediately before the male terminal 10 comes off from the female terminal 20. Also, with this configuration, the amount of the electric current flowing through the power supply path decreases due to the resistance value of the power supply path varying to a higher value. In view of this, if the amount of the electric current detected by the electric current detection unit 33 is lower than a threshold value, the electric conduction apparatus 1 can determine that there is a possibility that arc discharge will occur and stop power supply.

Note that the electric conduction system is installed in a vehicle in the present embodiment, but the present invention is not limited to this. This technology may also be applied to any system other than systems installed in a vehicle, and can be applied to a system having a configuration in which power is supplied by connecting the male terminal to the female terminal. Also, the shape of the male terminal 10 and the female terminal 20 shown in FIGS. 1 and 2 is a schematic shape shown as an example. The shape of the male terminal 10 and the female terminal 20 is not limited to the shapes shown in FIGS. 1 and 2, and may also be any other shape.

Also, the first resistance portion 11 and the second resistance portion 12 of the male terminal 10 have different resistance values by changing the type of plating, but the present invention is not limited to this. For example, the first resistance portion 11 and the second resistance portion 12 may also be prepared by joining two metal rods having different resistance values. Also, although the first resistance portion 11 is plated with tin and the second resistance portion 12 is plated with palladium or nickel, these are merely examples, and any materials may be used as long as materials have different resistance values. Moreover, although the resistance value R2 of the second resistance portion 12 is greater than the resistance value R1 of the first resistance portion 11, the present invention is not limited to these, and their magnitude relationship may also be reversed.

Also, the electric conduction apparatus 1 is configured such that the electric current detection unit 33 detects the amount of electric current flowing through the power supply path, the detected electric current amount is compared to a threshold value, and the electric conduction apparatus 1 stops power supply, but the present invention is not limited to this. A configuration may also be adopted in which the voltage value between both ends of a resistor disposed in the power supply path is detected instead of detecting the electric current amount, and the detected voltage value is compared with a threshold value, for example. Also, a configuration may be adopted in which the voltage value applied to the load 3 is detected in addition to the amount of the electric current value detected by the electric current detection unit 33, a resistance value is calculated using the detected electric current and voltage, and the calculated resistance value is compared to a threshold value, for example.

Although the electric conduction apparatus 1 is provided with the female terminal 20 and the harness 5 is provided with the male terminal 10, the present invention is not limited to this. A configuration may also be adopted in which the electric conduction apparatus 1 is provided with the male terminal 10 and the harness 5 is provided with the female terminal 20. Although the voltage of the power source is 48 V, the present invention is not limited to this.

Modification

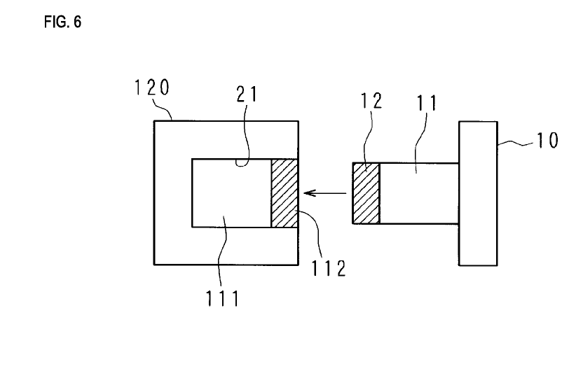

FIG. 6 is a schematic diagram showing the configuration of a male terminal 10 and a female terminal 120 according to a modification. The male terminal 10 according to the modification has the same configuration as the male terminal 10 shown in the above-described embodiment. In the female terminal 120 according to the modification, an inner surface of a hole 21 into which the male terminal 10 is inserted is provided with a first resistance portion 111 and a second resistance portion 112. The first resistance portion 111 of the female terminal 120 is provided over the circumference of the inner surface of the hole 21 on its back side with respect to the direction in which the male terminal 10 is inserted into the female terminal 120. The second resistance portion 112 is provided over the circumference of the inner surface of the hole 21 on its opening side.

The first resistance portion 111 and the second resistance portion 112 of the female terminal 120 have different resistance values by plating the inner surface of the hole 21 with different metals, for example. Letting the resistance value of the first resistance portion 111 of the female terminal 120 be R111 and the resistance value of the second resistance portion 112 be R112, metals for plating are selected such that R111<R112 is satisfied, for example. For example, it is conceivable that the first resistance portion 111 is plated with tin and the second resistance portion 112 is plated with palladium, nickel, or the like.

In a state in which the male terminal 10 and the female terminal 120 according to the modification are normally connected to each other, that is, in a state in which the rod-shaped portion of the male terminal 10 is inserted into the hole 21 of the female terminal 120 all the way to the rear end, the first resistance portion 11 of the male terminal 10 and the first resistance portion 111 of the female terminal 120 are in contact with each other and are electrically connected to each other. Let us consider a terminal disconnection where the male terminal 10 comes off from the female terminal 120 for some reason. At this time, only the second resistance portion 12 of the male terminal 10 and the second resistance portion 112 of the female terminal 120 are in contact with each other in a stage prior to the male terminal 10 completely coming off from the female terminal 120, and electric current flows between the second resistance portion 12 of the male terminal 10 and the second resistance portion 112 of the female terminal 120.

That is, the male terminal 10 and the female terminal 120 according to the modification are configured such that the resistance value of the power supply path through which the electric conduction apparatus 1 supplies power to the harness 5 varies depending on the position up to which the male terminal 10 is inserted into the female terminal 120. Because the amount of the electric current flowing from the electric conduction apparatus 1 to the harness 5 varies due to this change in the resistance value, the electric conduction apparatus 1 can detect that the male terminal 10 comes off from the female terminal 120 based on the amount of the electric current detected by the electric current detection unit 33.

1. An electric conduction system comprising:
a harness having a first terminal having a male terminal structure or a female terminal structure; and
an electric conduction apparatus having a second terminal that fits to the first terminal and has a female terminal structure or a male terminal structure, the electric conduction apparatus supplying power to the harness in a state in which the first terminal and the second terminal are fitted to each other,
wherein the first terminal and the second terminal are configured such that a resistance value of a power supply path through which the electric conduction apparatus supplies power to the harness varies depending on a position up to which a male terminal is inserted into a female terminal,
the electric conduction apparatus including
a detection unit configured to detect an amount of an electric current flowing to the harness through power supply, and
an electric conduction stopping unit configured to stop power supply if the amount of the electric current detected by the detection unit varies by a predetermined amount.

2. The electric conduction system according to claim 1,
wherein the male terminal has a first portion that has a first resistance value and is provided on its rear-end side and a second portion that has a second resistance value and is provided on its front-end side, with respect to a direction in which the male terminal is inserted into the female terminal.

3. The electric conduction system according to claim 2,
wherein the second resistance value is greater than the first resistance value.

4. The electric conduction system according to claim 3,
wherein the electric conduction stopping unit stops power supply if the amount of the electric current detected by the detection unit decreases.

5. (canceled)
